(19) United States
(12) Patent Application Publication
(10) Pub. No.: US 2017/0334234 A1
(43) Pub. Date: Nov. 23, 2017

(54) System and Method for Identifying the Source of Counterfeit Copies of Multimedia Works Using Layered Simple Digital Watermarks

(71) Applicant: Atlanta DTH, Inc., Norcross, GA (US)

(72) Inventor: John W. CURTIS, Lakemont, GA (US)

(21) Appl. No.: 15/598,915

(22) Filed: May 18, 2017

Related U.S. Application Data
(60) Provisional application No. 62/338,670, filed on May 19, 2016.

(51) Int. Cl. B42D 25/333; G06T 1/00; H04N 21/8358; H04N 21/4627; H04N 1/32

(52) U.S. Cl. CPC B42D 25/333; H04N 21/4627; H04N 1/32203; H04N 21/8358; G06T 1/0028; G06T 2201/005; H04N 2201/3233

(57) ABSTRACT

A system and method is provided for management of digital watermarks, including a system and method for identifying the source of counterfeit copies of multimedia works using layered simple digital watermarks which are difficult to locate, identify and circumvent. The layered digital watermarks may be modulated in a variety of ways, and may be individualized to assist in detection of unlawful copyrighted material infringement by endpoint device and/or the user committing the copyright infringement. In addition, multiple layers of watermarks may be selected and applied by various schemes, such as on-the-fly remotely by the distributor of the copyrighted material. This system and method for management of digital watermarks effectively makes it impossible for a potential copyright infringer to have complete confidence that they located and disabled all of the watermarks in the copyrighted material, and therefore substantially increases the risk of infringer identification and prosecution for copyright violations.

This application claims priority under 35 U.S.C. §119(e) to U.S. provisional application Ser. No. 62/338,670, filed May 19, 2016, the entire disclosure of which is incorporated by this reference into the present U.S. patent application.

### FIELD OF THE INVENTION

The present invention relates to digital watermarks, and more particularly to a system and method for identifying the source of counterfeit copies of multimedia works using layered simple digital watermarks.

### BACKGROUND OF THE INVENTION

A wide variety of techniques for embedding watermarks into multimedia works have been in use for many years. However, these older methods were susceptible to discovery or intentional removal by individuals attempting to circumvent the copy protection. In other some cases, such embedded watermarks were also susceptible to accidental removal.

Watermarks are based on modulating some aspect of a media transmission in such a way that the modulation can be later recovered and decoded. For steganographic watermarks, these changes must be small so that they can go unnoticed by the viewer. However, given the limited number of bits used to represent broadcast media programs the range of tolerable adjustments may be limited, for example, to one or two LSB steps, particularly for such basic parameters as Y, Cb, and Cr values. In sonic cases, such as over a large area of solid color, even a single bit of variation can become visible to the viewer.

One approach to avoiding easily-detected variations is to include a schedule feature to allow the mixture of simple watermarks to be periodically changed to prevent persons making and/or distributing unauthorized copies of multimedia works from knowing for sure exactly what the watermarking pattern is. Another approach is to adjust the intensity of the watermark based on the context. This context adjustment feature may be based on a prior analysis of the content being broadcast or a specified category of a live broadcast that is not available for prior analysis. The analysis or category specifies the appropriate level of watermark intensity for a particular section of content and is added to the watermark mode variation schedule applied to the watermarked content, so that the watermark intensity can be adjusted at the multimedia output player without the need for content analysis at the player. However, for on-demand content there is no equivalent approach available because there is no meaningful schedule (i.e., the nature of live-streaming is such that the multimedia works are not readily available for prior analysis). As a result, it may be the case that intensity and watermark mode settings can only be incorporated as part of a conditional access authorization process prior to a consumer receiving the multimedia content.

It is also the case that many of the existing approaches for watermarking digital content are primarily focused on embedding a generic copyright notice into the work, or identifying the copyright owner, or enabling automated searches for illegal copies. Many of these approaches require complex Fourier transform and psychoacoustic or psychovisual analysis of the content to improve either the robustness of the watermark or its degree of concealment. Most of these more advanced methods require specialized hardware to support the complexity of their methods.

Virtually all known watermarking methodologies combine, at the multimedia production and/or distribution sources, either the analog or digital representation of a multimedia work with the representation of the watermark which may be variously described as modulation, signal, noise, or auxiliary data. As such, existing approaches generally fail to anticipate the need for applying a watermark from within a generic rendering device, such as a set top box or handheld device. Trends in the distribution of copyrighted multimedia works are such that a need has arisen for watermarking material from within these platforms. However, these platforms generally lack the means to support any but the most basic of watermarking methods. Thus, while much of the existing watermarking approaches are focused on either identifying the copyright holder or marking the work as being copyrighted, there also exists a need to identify the endpoint of the distribution system (i.e. the particular user and display device) that generated a counterfeit copy so that the endpoint can be terminated and any future copying avoided.

### SUMMARY OF THE INVENTION

The present invention addresses the above shortcomings through a system and method of layered simple watermarks. In general, the present invention is based on the realization that, while a single simple watermark may be easy to locate and circumvent, layers of watermarks are much more difficult to identify. Moreover, removing some but not all of the watermarks will only serve to show an intent to defraud that is more easily prosecuted than an allegedly accidental publication of a copy made for personal use. The basic concept of any watermark is to deter unlawful use of copyrighted material by making it possible to demonstrate that the copy is unlawful. This deterrent is more effective when the watermark can be used to identify a particular device that made the copy or even a particular user. If, in addition, there are multiple layers of watermarks that can be selected, such as on-the-fly remotely by the distributor of the copyrighted material, then it becomes impossible for a potential pirate to have complete confidence that all of the watermarks have been located and safely disabled.

The present invention is also based on the enhancement of media security by dividing a media work such as a video into enhanced security segments that may be searched on an example basis, including by retrieval of corresponding security encoded segments, decoding of the segments, and comparison with a segment of the media of interest to identify changes and/or anomalies in the media segment indicative of unauthorized alteration and/or copying.

In accordance with the principles of the invention, the selection of simple watermarks is derived from those parameters of audio, video, text and other aspects of a multimedia work that can be altered slightly such that the change can be detected by instrumentation, but not by casual observation. These parameters include, but are not limited to, image brightness, audio phase relative to video, audio tone or equalization, image horizontal and vertical placement, video color temperature, anamorphic distortions, image black level, image hue, background noise floor, and text characteristics such as font size, boldness and tilt. These changes can be distributed spatially, temporally, or in other domains such as frequency or wavelet.

Since these changes are intended to impart a watermark that contains information, in the context of the present invention these changes are considered to be modulations of the associated parameter. The modulation strategy can include redundancy, bit scrambling and error correction coding to improve the ease with which the watermark can be read. These modulations of basic parameters are for the most part simple to apply using commonly available infrastructure elements in most display devices.

As a further measure to confound attempts to analyze the currently applied layers of watermarking, the invention may allow one or more of the layers to he without content such that there is nothing to decode. The intent of such layer(s) is to further increase the doubt in a potential pirate's mind that all watermarks have been located and disabled.

Architecturally, the application of watermarks must be integral to the decryption and decoding of a protected multimedia work with the goal e end user cannot access any copies of the presentation that lack watermarks.

in one preferred embodiment of the present invention, that of a set top box, the above items are sufficient to form a robust deterrent to the unlawful copying of copyrighted works. Since a set top box is a secure environment and set top box manufacturers must regularly certify that their design is resistant to tampering, it is a widely accepted standard of security in the business of distributing copyrighted works.

In the case of more generic handheld devices, however, security is less predictable. To that end, in an alternate preferred embodiment of the present invention, that of a handheld device, the decrypt-decode-watermark process is made more tamper resistant by adding one or more of the following features. The process is based on code that periodically or continuously sends tamper metrics back to the server as part of an encrypted handshake routine to confirm that an unaltered copy of the code remains in control of the process. Alternately, the process may be based on code that is incomplete, as stored in the handheld device, and relies on code (or pseudocode) embedded in the transmission of the multimedia work that is never stored on the handheld device, thus eliminating the possibility of fully reverse engineering the locally stored code. Further, the process is based on code that is sensitive to real-time delays, or other indications that the code has been halted even momentarily by a debug or dynamic code analysis tool, or that the multimedia stream has been stored and played back at a later time. Should any of these anti-tamper methods detect an issue, the system can be configured to take remedial action, such as triggering an automatic update or disabling/erasing the process altogether.

For a watermark such as in the present invention to be useful for forensic purposes, it must be practical to recover the watermark from illegally recorded video. As the decode process can be technically challenging, it is sometimes best for a user of the present invention to engage watermark decoding as an external service rather than an internal activity.

The present invention further provides for increased efficiency and security in watermark decoding. As the analysis and decoding of the layers of simple watermarks described herein are most readily accomplished as a comparison between the original work without watermark and the copy with watermark. The simplest way to reveal the watermark for analysis and decoding is to subtract out the original content leaving the watermark as a residual. However, in the context of a broadcast system there is the problem that original archive copies and illegal copies discovered on the Internet are not easily related, e.g., it is not clear where to find the original based on having a copy from the Internet. Moreover, in a system that is widely implemented, for each watermark decoding event this difficult matching process must be repeated an enormous number of times.

Access to the original content is also a problem, as broadcasters are concerned with the security risk associated with releasing an unsecured copy of original content from their secured archives for use in a watermark investigation. At a minimum, broadcasters may require editing the original content down to a shortened clip, so that even if that portion of the content was inadvertently released somewhere along the watermark application and/or decoding process, the broadcaster does not suffer the loss of a full copy of the content. However, because such content control requires manual processing of the content, this is not an efficient or economically attractive approach.

The need for security of the information being sent out and the need for efficiently locating the matching original and adding security features to the content sent for analysis are addressed in the present invention in part by the use a searchable archive of multimedia works. This approach reduces the process of locating the matching original to a simple database search, and the security issues raised by the need to send out an original from a secure facility may he addressed by structuring the archive in a manner that does riot make full copies of original content vulnerable to inadvertent release at any point in the watermarking system. For example, files may be stored at reduced resolution as compared to the original, the data may be segmented such that no one file contains a complete copy of the content (such as a complete movie or a complete television program), and/or by not sending out all of the segments of a program from the searchable archive to accomplish a decode. As a further security measure, all files sent from the archive may be encrypted.

One embodiment of the present invention is in the form of an added subsystem referred to in the industry as a “proof-of-play” system. A typical proof-of-play system makes a somewhat low resolution recording of the final broadcast stream including all inserted commercials. Its intended use is to validate to paying advertising customers that their commercials have been delivered in their intended program slots. Added to this system is a segmentation process that breaks the recording up into shortened portions (for example, 10 minutes each) that also align with the boundaries between programs based on the electronic program guide data. Each of those shortened portions would receive a hashing code, and the segmented portions would then be encrypted to further protect the content. Similarly, the subsystem is configured to segment a suspect copy and search for matching hash codes within the database of previously recorded programs. The combination in this embodiment of lower resolution, lack of any one file with a full length program, file encryption on top of secure HTTPS communications and constructing the decode service center in a secure facility address the security concerns, while simultaneously providing an indexed database of previously broadcast programs that may be readily used with an automatic search process to retrieve files needed for watermark decoding analyses.

It should be noted that while the process above is described in terms of recording a conventional broadcast, it is common knowledge that the broadcast industry is shifting heavily to streaming and on-demand services in which there really is no common broadcast, i.e., where each viewer individually retrieves files from a media server. One skilled in the art will recognize that the same the same kind of segmentation and indexing process can be employed in an Internet-based media distribution model, for example, based on a conventional broadcast stream being fed into the an Internet-based system or by directly interrogating the media files loaded into such a system.

One weakness of simple watermarks that is often remarked in the literature is that their effectiveness can be heavily dependent on the content of the audio and video being watermarked. To address these issues, in the present invention analysis or categorization of the multimedia programs being broadcast may be made to determine the optimal intensity and method for watermarking that program or category of programs. This information may be incorporated into the watermark variety schedule and passed to the endpoint display devices, thus relieving the endpoint display devices of the need to do that analysis on the fly.

The present invention may also be configured to address the problem arising from the variety of video contexts that simple watermarks may either wash out or become too visible if not adjusted to suit the context. This is addressed by pre-analyzing the source video to optimize the watermark application to specific a video and/or audio construct, and make the resulting data available to the watermark system that schedules the variety in the watermark. The adjustment of the watermark intensity may then be incorporated by the watermark systems as another parameter to be included in a watermarking schedule. As a practical matter, the majority of the target output players in the market lack the hardware resources to be able to analyze and implement such a watermarking scheme in real time.

A further aspect of the present invention includes addressing security concerns in the context of a web browser. It is well known in the industry that web browsers are aggressively probed for weaknesses by “hackers” seeking to defeat security protections, and such weaknesses are commonly found. For a watermark to be effective, it must be applied in a protected environment that is resistant to efforts to extract a clear copy of the multimedia work prior to watermarking. A web browser typically is not such an environment.

The present invention may provide enhanced security in a web browser environment by providing an additional background application that serves as a secure execution environment. Many interfaces between the background application and the web browser are possible. In a preferred embodiment, the background application is constructed as a nano-scale proxy server which may be accessed like any other web site from the browser. The Javascript content of the remote web site may also be constructed to make this routing invisible to the user.

This approach is similar in intent to the Encrypted Media Extensions of HTML5, but has the advantage of being more extensible and browser independent. A further advantage is that it is a specialty application not subject to as much attention from the hacking community as are the main standardized aspects of HTML. While the application must be made native to each intended execution environment, this is not unlike the current accepted practice for mobile applications, and therefore this disadvantage is not a major deterrent to the approach.

The present invention's advantages include: (i) the ability to be implemented using circuits that are commonly available in all modern multimedia-capable processors because the watermarks on which the method of the present invention are relatively simple, i.e., there is a significant system cost reduction because no special hardware is required within the STBs and smart devices; (ii) the ability to entirely implement the present invention in software, including software that substantially increases the utility and functionality of the associated electronic devices, i.e., the system may be readily implemented across a broad spectrum of the multimedia distribution marketplace, requiring only access to the STB firmware and a set of player apps for common smart devices; and (iii) enabling future improvements in multimedia security to be readily incorporated because the security of the present invention is based on variety rather than complexity, and therefore the range of watermarking strategies may be readily expanded as additional hardware features friendly to watermarking are released in future hardware. While these and other benefits potentially require the present invention to use more complex decoding processes, this is off-set to some extent by the fact that the number of decode points needed are very few as compared to the number of display endpoints. Thus, even with this trade off the present invention provides a system with significant economic advantages compared to with prior approaches.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples. The disclosure is written for those skilled in the art. Although the disclosure uses terminology and acronyms that may not be familiar to the layperson, those skilled in the art will be familiar with the terminology and acronyms used herein.

### BRIEF DESCRIPTION OF THE DRAWINGS

FIG. 1A illustrates a block diagram of a bidirectional set-top-box-based system, configured in accordance with the principles of the invention;

FIG. 1B illustrates a block diagram of a unidirectional set-top-box-based system, configured in accordance with the principles of the invention;

FIG. 1C illustrates a block diagram of a handheld-device-based system, configured in accordance with the principles of the invention;

FIG. 1D illustrates a block diagram of a set-top-box-based system cascaded to local handheld devices, configured in accordance with the principles of the invention;

FIG. 2 illustrates one embodiment of a code flow chart for a set top box, arranged in accordance with the principles of the invention.

FIG. 3 illustrates one embodiment of a code flow chart for a handheld device, arranged in accordance with the principles of the invention;

FIG. 4 illustrates one embodiment of a code flow chart for a watermark server, arranged in accordance with the principles of the invention;

FIG. 5A illustrates one example of unmodulated video frames;

FIG. 5B illustrates one example of spatially distributed luminance modulation;

FIG. 5C illustrates one example of temporally distributed luminance modulation;

FIG. 6A illustrates one example of spectrally distributed audio equalization modulation;

FIG. 6B illustrates one example of temporally distributed audio equalization modulation;

FIG. 7 illustrates one embodiment of a code flow chart for a watermark decoder, arranged in accordance with the principles of the invention; and

FIG. 8 illustrates one embodiment of a code flow chart for a watermark decode file match server, arranged in accordance with the principles of the invention.

FIG. 9 illustrates one embodiment of a system architecture supporting matching of a watermarked copy to an original, in accordance with the principles of the invention.

FIG. 10 illustrates one embodiment of a system architecture supporting watermark context analysis, in accordance with the principles of the invention.

FIG. 11 illustrates one embodiment of a system in which security of watermark application in a web browser environment is enhanced by a hard coded application separate from the web browser, in accordance with the principles of the invention.

FIG. 12 illustrates one embodiment of a code flow chart for a hard coded security application separate from the web browser, in accordance with the principles of the invention.

### DETAILED DESCRIPTION OF THE INVENTION

The present invention is described in the context of broadcast systems, such as cable, satellite, IPTV and streaming broadcast systems, and content output devices, such as a set top box and a handheld display device, in which a plurality of watermarking methods are available to identify the device and/or the associated user. These watermarking methods may be selectively enabled or disabled according to a watermarking strategy transmitted from a watermarking server at the broadcast headend to each set top box and/or handheld display device. The present invention is not limited to only the foregoing, and includes other systems and content output devices, including those used for scheduled streaming, on-demand streaming, on-demand file transfer, and social media.

The watermarking system, in the example of use with a set top box, includes the following components:
a watermark server,
a transport stream multiplexer that merges the main program stream with the data from the watermark server,
a program distribution network,
a set top box, and
at least one display device.

The watermark server may include a watermarking database containing:
a table of authorized set top boxes and/or other registered display devices,
a table of watermarking codes that correspond to each set top box and registered display device,
a table of registered users,
a table of watermarking codes that correspond to each registered user,
a table of watermarking methods showing which ones are available in each type of set top box or other display device,
a table of watermarking strategies that are combinations and/or sequences of individual steganographic and overt watermarks,
a table of program schedules such that watermarking logs can be tied back to particular programs and watermarking strategy changes can be coordinated to shift between programs,
a table of planned watermarking strategies based on program schedules, devices and/or system configuration, and
a table of watermarking log entries that associate particular programs with particular set top boxes, users, or other display devices, particular watermarking strategies in use at the time and the date and time of the entry.

The above described watermark server may be configured to transmit watermarking codes and/or strategies to set top boxes and other display devices. In addition, watermarking algorithms may be transmitted to set top boxes and other display devices either as static code or as on-the-fly code or pseudocode embedded in the program transport stream. Moreover, the watermark server may be configured to transmit status query messages to set top boxes and other display devices and for receiving and logging responses received from the set top boxes and other display devices.

With respect to a set top box configured in accordance with the principles of the invention, such a device may be configured to render multimedia content on a display device. Such a set top box may also be configured to receive watermarking codes and strategies from the aforementioned watermark server.

The set top box may also be configured to receive the watermarking algorithms from the above watermark server either as static code or as on-the-fly code or pseudocode embedded in the program transport stream, as well as to receive status query messages from the watermark server and to transmit any required responses back to the server.

Another aspect of the invention relates to methods for applying watermarking algorithms to modulate the watermarking code onto one or more program parameters in accordance with a currently active watermarking strategy.

Still another aspect of the invention relates to retransmitting a program stream to a handheld display device with the watermarking already embedded in the program content or with watermarking instructions tightly bound to the program stream.

It should be appreciated that the present invention may incorporate methods for applying watermarking algorithms in, at a minimum. One or more of the following forms: modulating image brightness, modulating audio phase relative to video, modulating audio tone or equalization, modulating image horizontal and vertical placement, modulating video color temperature, modulating image anamorphic distortions, modulating image black level, modulating image hue, modulating background noise floor, modulating text characteristics such as font size, boldness and tilt, and modulating any other available characteristic of the multimedia program.

All of the modulation methods above may be based on changes that may be distributed spatially, temporally, or in other domains such as frequency or wavelet.

In one embodiment, a system configured in accordance with the principles of the invention may be configured to populate watermarking server database tables in a watermark server, provide connectivity from the watermark server to the transport stream and the Internet, and to roll out watermark programming and/or related watermark data to watermark capable set top boxes and apps for other display devices. The system may also be configured to either automatically vary the watermarking strategy or o expect changes to the watermarking strategy to be a part of the daily schedule. The system may establish and enter either a daily schedule or a recurring schedule for the control of watermark strategy timing if enabled above.

In certain embodiments, the system operates by having a watermark server maintain a dialog with each connected endpoint device to confirm that each is authorized, has assigned watermark codes and shows no evidence of tampering. It should be appreciated that, in systems that lack a return path to the head end, an authorization/watermark code may be transmitted on demand and retained by the device.

As part of the system, the watermark server may transmit the watermark strategy schedule to each endpoint. Each connected display device may correspondingly receive and store its watermark codes and the watermark strategy schedule. As a multimedia program is displayed on a connected display device, the program is rendered while embedding whichever watermarks are required by the current watermark strategy schedule.

For enhanced security and efficiency of operation, optionally the watermarking system may further include a searchable archive of previously broadcast multimedia programs. Such an archive may further be configured to:
monitor and record broadcast multimedia programs,
decrypt those programs if content protection is in use,
monitor electronic program guide data and broadcast schedule data to extract metadata for inclusion in the aforementioned recordings,
divide the recorded stream into file segments that align with program boundaries and further break each program into multiple files,
extract features from each file segment that are characteristic of the file to enable search-by-example functionality,
analyze previously watermarked files to create file segments and searchable characteristic features compatible with the aforementioned broadcast recordings,
hold in a database the recorded file segments, their metadata and their extracted features,
retrieve file segments that match a selected file segment, and
encrypt both the selected and retrieved file segments and send them to the watermark decoder system for analysis.

For enhanced concealment and readability of the watermark, optionally the watermarking system a further be configured for watermark optimization by specifying both the tensity of the watermark and the watermarking strategy that is most appropriate for a particular multimedia work or for a category of multimedia works. Alternatively, watermark optimization may be configured as a function of a determination if the media's general category.

The embodiment of the control aspects of the present invention will vary in accordance with the nature of the multimedia program delivery system into which it is incorporated. In the case of a conventional DBV-S or similar one-way broadcast system, control of the watermark is embedded into the transport stream as ancillary data, and each endpoint device monitors the stream extracting whatever control data is appropriate for its use. In the case of an IPTV system, much the same control strategy can be employed but there is the added benefit of a return path from each endpoint that can be used for gathering endpoint status and reports of tampering with the security of the watermark system. In the case of an Internet live streaming or on-demand program delivery system, the customary audio/video delivery mechanism may make no allowances for ancillary data, forcing the watermark system to rely instead on a client-server relationship between the endpoint display devices and the broadcast studio for control of the system. This implies that control data is requested by each endpoint individually rather than being pushed from the server en masse as in the previous cases. One skilled in the art will recognize that communications between the distribution point for the multimedia programs and the end point display devices must exist for the present invention to function, but its precise nature is not central to the invention.

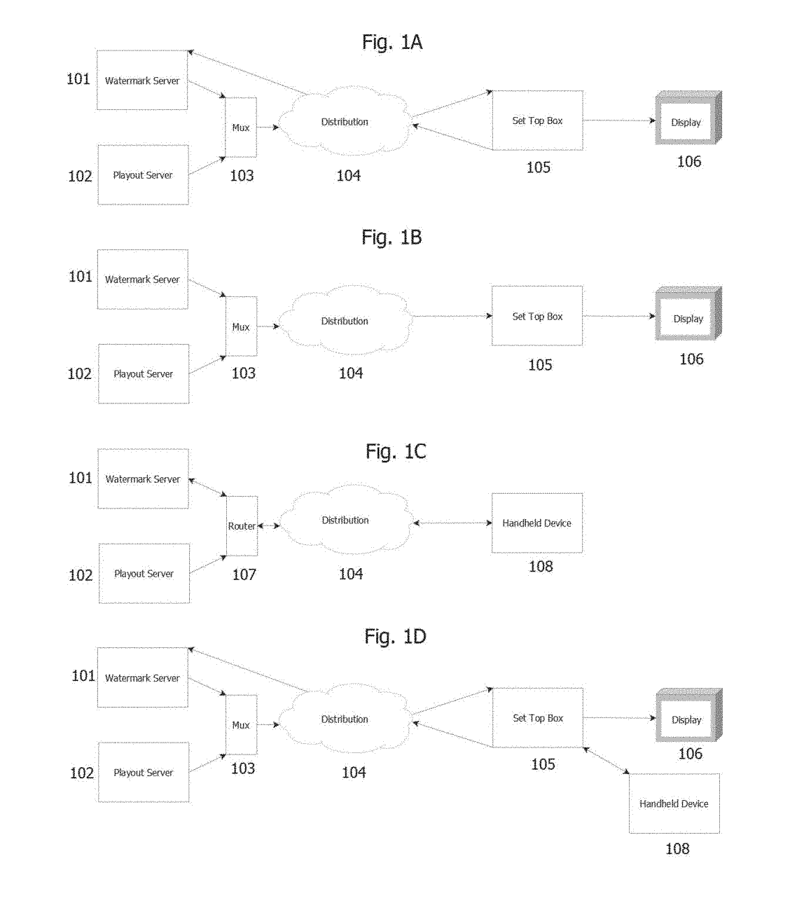

Embodiments of the present invention are now described in conjunction with the Figures. FIGS. 1A-1D illustrate various arrangements of a system configured in accordance with the principles of the invention. In particular, FIG. 1A depicts one embodiment of a bidirectional set-top-box-based system in which a watermark server 101 provides watermark information to be applied to content from playout server 102 in mixer 103. The watermarked content is then forwarded through the distribution medium 104, such as a cable provider network or the Internet, to a set top box 105. The decoded content, with the watermark data, is then presented on a display device 106. As indicated by the communications direction arrows, the set top box 105 may provide information to, and request information from, the watermark server 101, as described further below.

FIG. 1B depicts an embodiment of a unidirectional set-top-box-based system similar to that of FIG. 1A, wherein the set top box 105 cannot provide information to the watermark server 101.

FIG. 1C depicts an embodiment of a handheld-device-based system n this embodiment, the mixing of watermark information and media content from the watermark server 101 and playout server 102 is performed by a router 107, similar to the muxing conducted in the FIG. 1A mux 103. The watermarked content is then delivered via distribution medium 104 to the handheld device 108 for decoding and presentation on the handheld device's integrated display. Unlike the FIG. 1A embodiment, in the FIG. 1C embodiment communications from the handheld device 108 to the watermark server 101 are routed through the router 107.

FIG. 1D is an embodiment of a set-top-box-based system as in the FIG. 1A embodiment, in which the set top box 105 is also configured to pass watermarked content to a local handheld device 108, in addition to the display device 106. In this embodiment both the set top box 105 and the handheld device 108 may provide information to the watermark server.

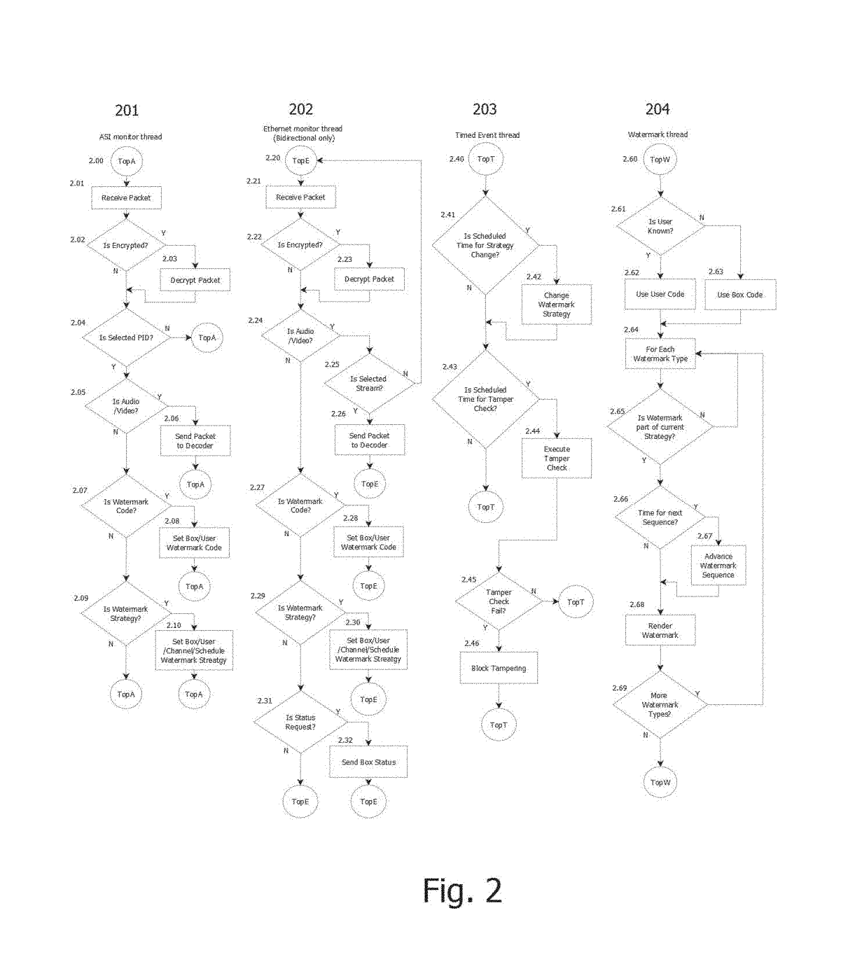

FIG. 2 illustrates an embodiment of programming for a set top box, including four code threads, an Asynchronous Serial Interface (“ASI”) monitor thread 201, an Ethernet monitor thread (for bidirectional systems) 202, a timed event thread 203, and a watermark thread 204. Of course, one skilled in the art will recognize that the programming in the set top box will not be limited to only these four code threads, and that the set top box may execute additional threads before, concurrently with, or after these threads.

The processes for managing the watermark in this embodiment are coded as at least three of these four threads running concurrently. A first thread manages broadcast data handling decryption, channel selection and watermark control: the ASI monitor thread is used for unidirectional DVB systems and the Ethernet monitor thread is used for bidirectional IPTV systems. A second thread manages the watermark variety schedule, and a third thread manages the actual insertion of the watermark, particularly those that are applied in a temporal sequence. One skilled in the art would see that a set top box could also be managed by other methods such as the one described for handheld devices below.

These processes are described in more detail as follows.

ASI Monitor Thread. The ASI monitor thread 201 manages data received from a broadcast stream, in this embodiment a DVB broadcast stream. The thread begins at step 2.00 (identified in FIG. 2 as “TopA”). At step 2.01 a packet is received from the distribution medium 104, and at step 2.02 the system tests for the presence of encryption in the packet. If encryption is determined to be present, the packet is passed to step 2.03 for decryption before continuing. After decryption (or if no encryption is identified in step 2.02), the packet is examined in step 2.04 to determine whether the packet's Packet Identifier (PID) is associated with one of the streams that are currently selected for use by the end user. If not, control reverts back to step 2.00, and the system awaits arrival of the next packet.

If at step 2.04 it is determined that the packet is part of an active stream, the packet is tested at step 2.05 to determine whether the packet contains video and/or audio data. If video and/or audio data is present, the packet is forwarded to the set top box's video and/or audio decoder for decoding at step 2.06, and control reverts back to step 2.00 to await receipt of another packet from the distribution medium 104.

If at step 2.05 it is determined that the packet not include video and/or audio data, audio/video data, control proceeds to step 2.07. At step 2.07 the packet is tested to determine whether it contains an update to the watermark ID code for the set top box. If a watermark ID code update is present, at step 2.08 the watermark ID code is saved in the set top box for later use.

If at step 2.07 the system determines that the packet does not include a watermark ID code, the packet is tested at step 2.09 to determine whether it contains an update to the watermark strategy schedule. If a watermark strategy schedule update is present, at step 2.10 the watermark strategy schedule update is saved in the set top box for later use. In either case, control reverts back from step 2.09 or step 2.10 to step 2.00 to await receipt of another packet from the distribution medium 104.

The present invention is not limited to the specific ASI processing described above. For example, the system may be configured to determine whether a received packet contains mix of information type (for example, video and/or audio and watermark data), and parse the content of the packet accordingly.

Ethernet Monitor Thread. The Ethernet monitor thread manages data received as part of an IPTV broadcast stream or the set top box feedback portion of an ASI-based broadcast system, starting at step 2.20 (identified in FIG. 2 as “TopE”). At step 2.21 a packet is received from the distribution medium 104, and at step 2.22 the system tests for the presence of encryption in the packet. If encryption is determined to be present, the packet is passed to step 2.23 for decryption before continuing. After decryption (or if no encryption is identified in step 2.22), the packet is examined in step 2.24 to determine whether the packet contains video and/or audio data. If video and/or audio data is present, the packet is next tested at step 2.25 to determine whether the packet's PID is associated with one of the streams that are currently selected for use by the end user. If not, control reverts back to step 2.20, and the system awaits arrival of the next packet. If at step 2.25 it is determined that the packet is part of an active stream, the packet is forwarded to the set top box's video and/or audio decoder for decoding at step 2.26, and control reverts back to step 2.20 to await receipt of another packet from the distribution medium 104.

If it is determined in step 2.24 that the packet does not contain video and/or audio data, at step 2.27 the packet is tested to determine whether it contains an update to the watermark ID code for the set top box. If a watermark ID code update is present, at step 2.28 the watermark ID code is saved in the set top box for later use.

If at step 2.27 it is determined that the packet does not contain an update to the watermark ID code for the set top box, then at step 2.29 the packet is tested to determine whether it contains an update to the watermark strategy, such as an update to the watermark schedule. If a watermark strategy update is present, at step 2.30 the watermark strategy change ID is saved in the set top box for later use.

If it is determined in step 2.29 that the packet does not a schedule update, the packet is tested at step 2.31 to determine whether the packet includes a request from the server for status from the set top box. If such a request is present the request is forwarded for processing at step 2.32 to send the requested set top box status information back to the server. In either case, control reverts back from step 2.31 or step 2.32 to step 2.00 to await receipt of another packet from the distribution medium 104.

Timed Event Thread. The Timed Event Thread controls events that need to happen at a scheduled time. Beginning at step 2.40 (identified in FIG. 2 as “TopT”), at step 2.41 the system compares the current time to the scheduled time for the next watermark strategy change. If the current time has reached the scheduled time, at step 2.42 the set top box executes a change to the active watermark strategy to match the now-current watermark strategy.

Regardless of whether a watermark strategy change is implemented, control passes to step 2.43, where the system compares the current time to the time for the next scheduled tamper check. If the current time has not reached the scheduled time, control reverts back to step 2.40 to re-start the thread

If the current time has reached the scheduled time, at step 2.44 the set top box executes a tamper check to determine whether there have been any attacks on the security of the system. At step 2.45, if the system determines that the result of the tamper check was satisfactory, control reverts back to step 2.40. On the other hand, if the system determines that the tamper check was failed, control moves to step 2.46 to cause action to block tampering, for example, by reloading software, disabling the set top box or other remedial action. Control then reverts back to step 2.40 to re-start the thread.

Watermark Thread. The Watermark Thread manages the rendering of watermarks on the set top box output. In some set top boxes it may be possible to identify the user, in addition to being able to identify the individual set top box. Beginning at step 2.60 (identified in FIG. 2 as “TopW”), at step 2,61 the system checks to see if the user is known. If the user is known the system at step 2.62 identifies the user code for use in further processing; otherwise at step 2.63 the individual set top box code is identified for use.

At step 2.64, the system begins to execute a loop that runs for each type of watermark. Specifically, at step 2.65 the system first compares the current watermark type to the current watermark strategy to determine whether the current watermark type is part of the current watermark strategy. If not, control reverts to step 2.64 for the next watermark type.

If the current watermark type is part of the current watermark strategy, at step 2.66 the system determines whether the current watermark type is a temporal sequential watermark, and if so, whether it is time for the next step in the temporal sequence. If it is time for the next step in the sequence, at step 2.67 the sequence for the current watermark is advance to the next step. At step 2.68 the current state of the current watermark is rendered to be presented in the set top box output.

At step 2.69 the system checks whether there are more watermark types to loop through, and either shifts control back to the beginning of the loop at step 2.64, or reverts back to step 2.60 to await receipt of another packet from the distribution medium 104.

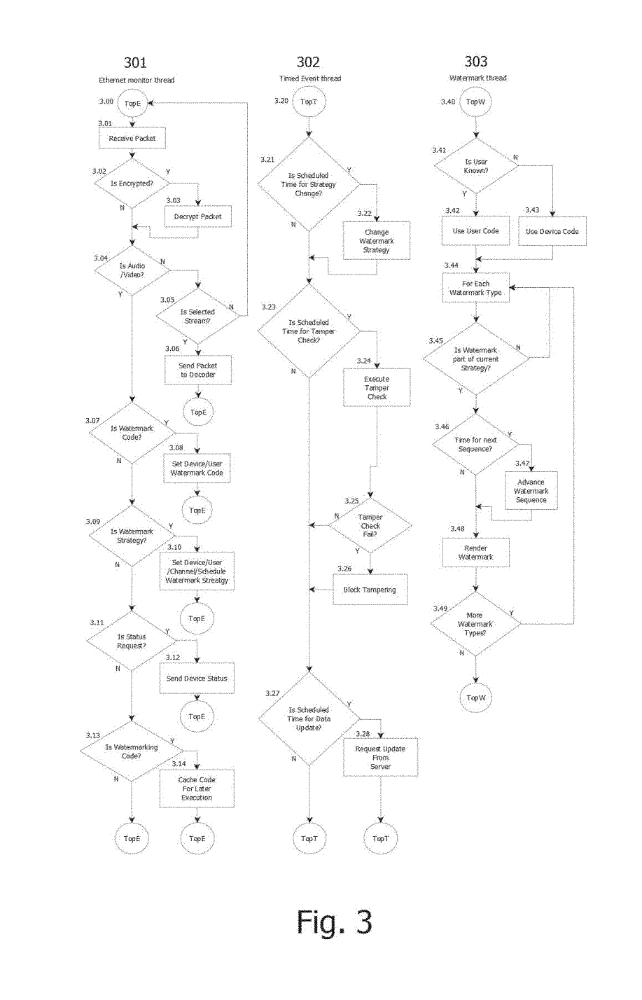

FIG. 3 illustrates one embodiment of a code flow chart for managing watermarks on a handheld device such as a smart phone using three concurrent threads. An Ethernet monitor thread 302 manages broadcast data handling decryption, channel selection, watermark control and status reports. This thread differs from its set top box counterpart in FIG. 2 in that Internet streaming video lacks a convenient mechanism for including embedded control codes so it is simpler to have the device request this data from the server using a more conventional client server model. A timed event thread 303 manages the watermark variety schedule, and a watermark thread 304 thread manages the actual insertion of the watermark, including watermarks that are applied in a temporal sequence. Of course, one skilled in the art will recognize that the handheld device may execute additional threads before, concurrently with, or after the aforementioned threads, and that a handheld device may also be managed by other methods.

Ethernet Monitor Thread. The Ethernet monitor thread manages data received as part of an Internet video stream, as well and other control data received via Ethernet. The thread 302 begins at step 3.00 (identified in FIG. 3 as “TopE”). At step 3.01 a packet is received from the distribution medium 104, and at step 3.02 the system tests for the presence of encryption in the packet. If encryption is determined to be present, the packet is passed to step 3.03 for decryption before continuing. After decryption (or if no encryption is identified in step 3.02), the packet is examined in step 3.04 to determine whether the packet contains video and/or audio data. If video and/or audio data is present, the packet is next tested at step 3.05 to determine whether the packet's PID is associated with one of the streams that are currently selected for use by the end user. If not, control reverts back to step 3.00, and the system awaits arrival of the next packet. If at step 3.05 it is determined that the packet is part of an active stream, the packet is forwarded to the handheld device's video and/or audio decoder for decoding at step 3.06, and control reverts back to step 3.00 to await receipt of another packet from the distribution medium 104.

If it is determined in step 3.04 that the packet does not contain video and/or audio data, at step 3.07 the packet is tested to determine whether it contains an update to the watermark ID code for the handheld device. If a ark ID code update is present, at step 3.08 the watermark ID code is saved in the handheld device for later use.

If at step 3.07 it is determined that the packet does not contain an update to the watermark ID code for the handheld device, then at step 3.09 the packet is tested to determine whether it contains an update to the watermark strategy, such as an update to the watermark schedule. If a watermark strategy update is present, at step 310 the watermark strategy change ID is saved in the handheld device for later use.

If it is determined in step 3.09 that the packet does not a schedule update, the packet is tested at step 3.11 to determine Whether the packet includes a request from the server for status from the handheld device. If such a request is present the request is forwarded for processing at step 3.12 to send the requested handheld device status information back to the server.

At step 3.13 the system determines whether the packet is part of a block of a dynamically sent watermark procedure. If so, it is cached at step 3.14 for later execution. In either case, control reverts back from step 3.13 or step 3.14 to step 3.00 to await receipt of another packet from the distribution medium 104.

Timed Event Thread. The Timed Event Thread controls events that need to happen at a scheduled time. Beginning at step 3.20 (identified in FIG. 3 as “TopT”), at step 3.21 the system compares the current time to the scheduled time for the next watermark strategy change. If the current time has reached the scheduled time, at step 3.22 the handheld device executes a change to the active watermark strategy to match the now-current watermark strategy.

Whether or not a watermark strategy change is implemented, control passes to step 3.23, where the system compares the current time to the time for the next scheduled tamper check. If the current time has not reached the scheduled time, control reverts back to step 3.20 to re-start the thread.

If the current time has reached the scheduled time, at step 3.24 the handheld device executes a tamper check to determine whether there have been any attacks on the security of the system. At step 3.25, if the system determines that the result of the tamper check was satisfactory, control continues to step 3.27. On the other hand, if the system determines that the tamper check was failed, control moves to step 3.26 to cause action to block tampering, for example, by reloading software, disabling the handheld device or other remedial action. Control then continues to step 3.27.

At step 3.27, the system determines whether the current time has reached a schedule time for the next data update from the watermark server. If the current time has reached the scheduled time, at step 3.28 the handheld device sends a request for an update to the watermark server.

Watermark Thread. The Watermark Thread manages the rendering of watermarks on the handheld device output. In some handheld device it may be possible to identify the user, in addition to being able to identify the individual handheld device. Beginning at step 3.40 (identified in FIG. 3 as “TopW”), at step 3.41 the system checks to see if the user is known. If the user is known the system at step 3.42 identifies the user code for use in further processing; otherwise at step 3.43 the handheld device code is identified for use.

At step 3.44, the system begins to execute a loop that runs for each type of watermark. Specifically, at step 3.45 the system first compares the current watermark type to the current watermark strategy to determine whether the current watermark type is part of the current watermark strategy. If not, control reverts to step 3.44 for the next watermark type.

If the current watermark type is part of the current watermark strategy, at step 3.46 the system determines whether the current watermark type is a temporal sequential watermark, and if so, whether it is time for the next step in the temporal sequence. If it is time for the next step in the sequence, at step 3.47 the sequence for the current watermark is advance to the next step. At step 3.48 the current state of the current watermark is rendered to be presented in the handheld device output.

At step 3.49 the system checks whether there are more watermark types to loop through, and either shifts control back to the beginning of the loop at step 3.44, or reverts hack to step 3.40 to await receipt of another packet from the distribution medium 104.

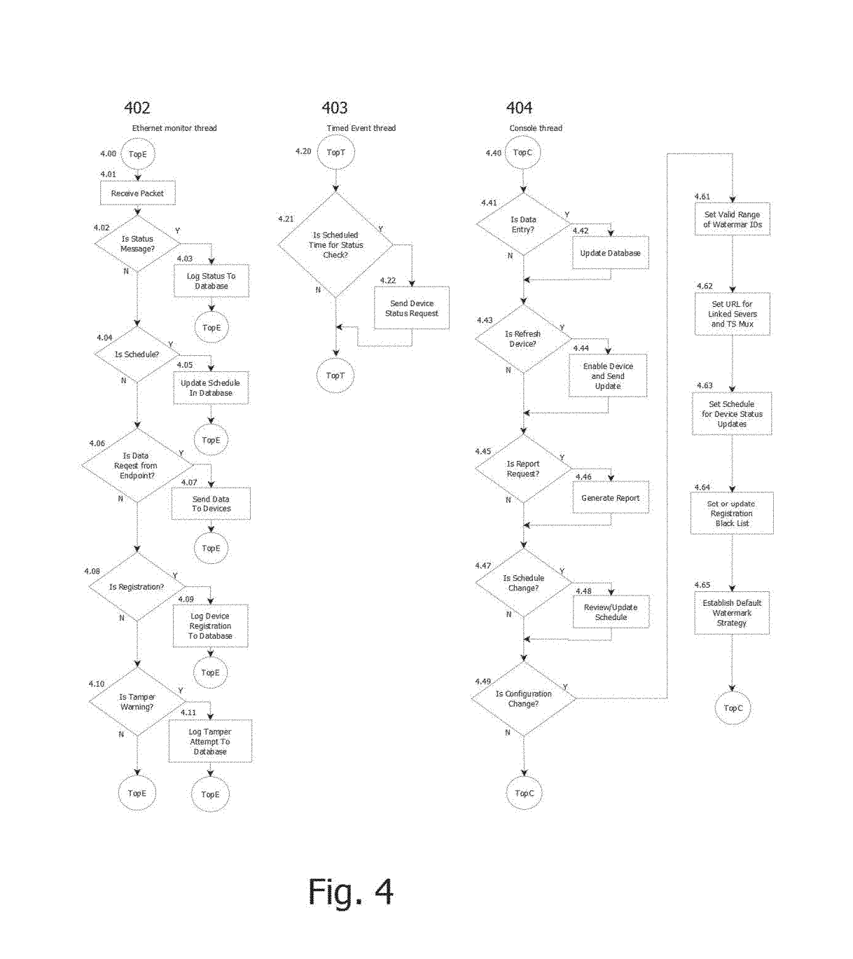

FIG. 4 illustrates one embodiment of a code flow chart for managing the data required to operate the watermarking system using three concurrent threads at a watermark server. The watermark server in this embodiment is configured to execute a corresponding server-side Ethernet monitor thread 402 to manage communications with endpoint devices such as set top boxes, smart devices, and with other head-end systems such as the conditional access control system with which the watermark server needs to interchange data. A timed event thread 403 manages timed queries for endpoint device status, and a watermark thread 404 manages actions requested from the server console. Again, one skilled in the art will recognize that the watermark server may execute additional threads before, concurrently with, or after the aforementioned threads, and that a watermark server may also be managed by other methods.

Ethernet Monitor Thread. The Ethernet monitor thread manages data received via Ethernet. The thread 402 begins at step 4.00 (identified in FIG. 4 as “TopE”). At step 4.01 a packet is received. At step 4.02 the system determines whether the packet contains a status message from an endpoint device, such as a set top box or a handheld device. If so, at step 4.03 the received status data is logged into a database for later use, and control reverts back to step 4.00.

If at step 4.02 it is determined that the packet does not contain status information, at step 4.04 the packet is checked to determine whether watermark schedule information is present that needs to be imported into the watermark variety schedule. If watermark schedule data is determined by the system to be present, the watermark variety schedule is updated in the database in step 4.05.

At step 4.06 the system determines whether the packet includes a data request from an endpoint device. If such a request is present, the system in step 4.07 forwards the requested data to the requesting endpoint device, followed by reversion of control back to step 4.01 to wait for the next packet.

If it is determined in step 4.06 that the packet does not include a data request from an endpoint device, at step 4.08 the system determines whether it contains registration data that will be used to identify the endpoint device and/or user with a watermark ID. If present, the registration data is logged to the database at step 4.09.

At step 4.10 the packet is checked to determine whether it contains a tamper warning from an endpoint device, and any such event is logged to the database in step 4.11. Whether or not tamper warning information is present in the packet, control reverts back from step 4.10 or step 4.11 to step 4.00 to await receipt of another packet.

Timed Event Thread, The Timed Event Thread controls events at the watermark server that need to happen at a scheduled time. Beginning at step 4.20 (identified in FIG. 4 as “TopT”), at step 4.21 the system compares the current time to the scheduled time for the next status check. If the current time has reached the scheduled time, at step 4.22 the watermark server sends a status request to the endpoint device(s). Control then reverts back to step 4.20 to re-start the thread.

Console Thread. The Console Thread manages action requests from the system operator via the server console. Beginning at step 4.40 (identified in FIG. 4 as “TopC”), at step 4.41 the system checks to determine whether an operator input is a data entry operation. If so, in step 4.42 the data from the operator is used to update the corresponding database.

The system at step 4.43 next determines whether the operator input is an endpoint device refresh request, and in response to such a request at step 4.44 identifies the endpoint device as active in the system, sends watermark ID and schedule data to stream-based devices, such as handheld devices.

At step 4.45 the system determines whether the operator input is a request for a report. If a report request is present, the system generates the requested report at step 4.42, and control reverts to step 4.40.

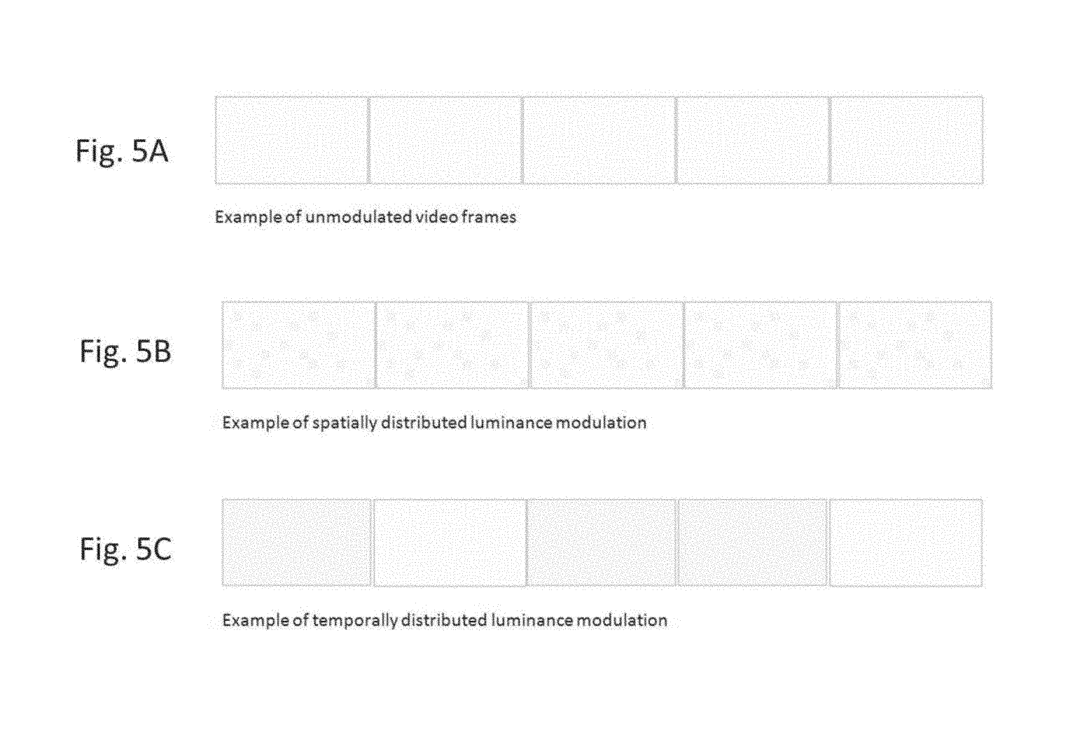

FIGS. 5B-5C illustrate examples of approaches to watermarking that may be used to implement one or more aspects of the invention. Beginning with a series of unmodulated video frames shown in FIG. 5A, FIG. 5B illustrates example of spatially-distributed luminance modulation, in which luminance is varied at different locations within the image frames. FIG. 5C illustrates an example of temporally-distributed luminance modulation, in which luminance may be varied over time, i.e., over multiple image frames.

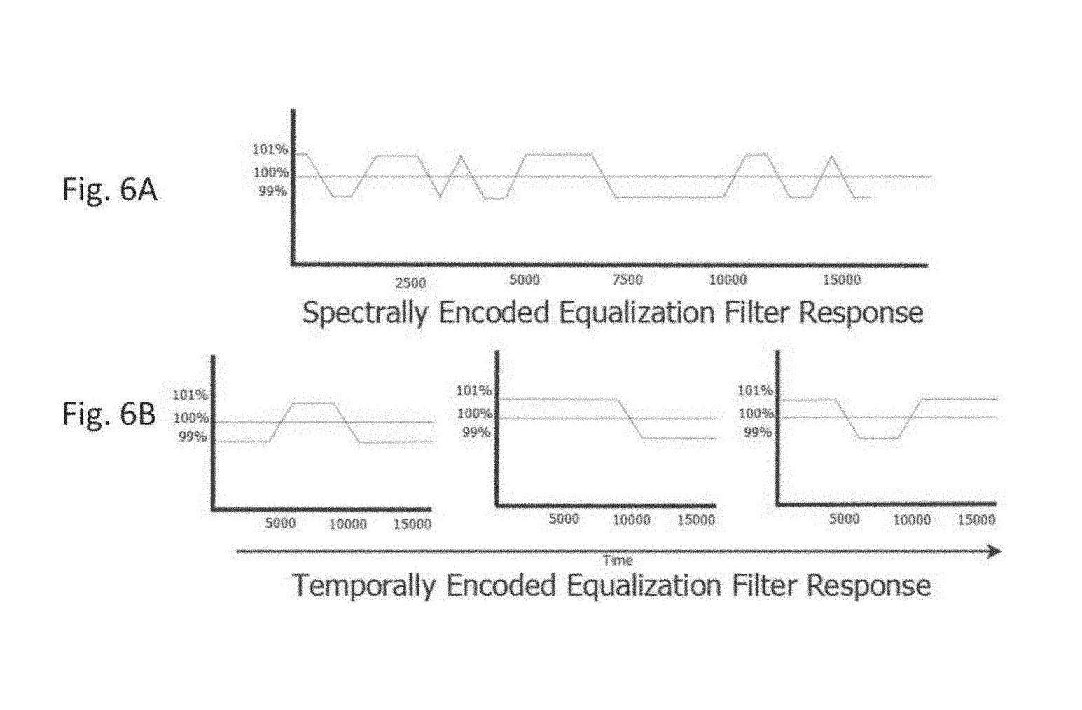

Similarly, FIGS. 6A-6B illustrate examples of distributed audio equalization modulations which may be used to implement one or more aspects of the invention, with FIG. 6A illustrating an example of spectrally-encoded modulation across a range of frequencies (in FIG. 6A, from below 2,500 Hz to over 15,000 Hz). FIG. 6B illustrates similar spectral modulation, combined with temporal changes in the spectral modulation over time.

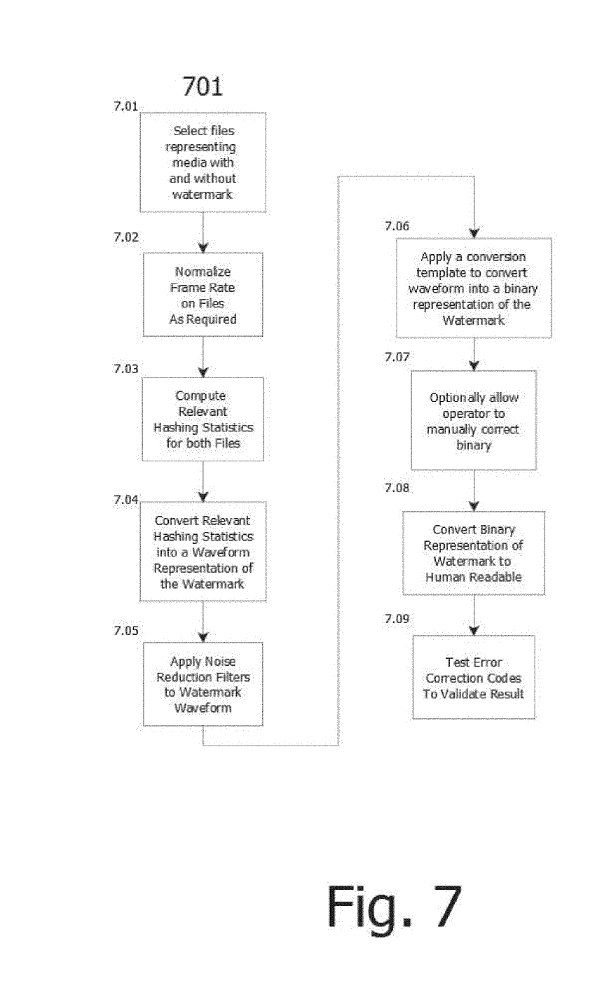

The decoding of a watermark is based on the idea that where watermarks are modulations of a particular parameter of a multimedia work, that modulation may be measured and converted to a digitized waveform. The digital waveform may then be analyzed using the full range of digital signal processing techniques that are available for other aspects of audio/video production. An example embodiment of a process of decoding a watermark is described with the aid of FIG. 7.

At the beginning of decoding thread 701 the user at step 7.01 selects files representing the multimedia work being examined in both watermarked and not-watermarked form. These files can be the original multimedia production files or can be previous reductions of those files to parameter hashing data. At step 7.02 the frame rates of the files are normalized to allow frame-by-frame comparison that is useful for some forms of sequential watermarks. Next, at step 7.03, the parameters of the original multimedia work that have been modulated with the watermark are reduced to hashing statistics, either from the original production file or from the results of some previous analysis. These hashing statistics are then converted in step 7.04 into a digital waveform representation of the particular watermark being analyzed.

At step 7.05, in a manner known to one skilled in the art, various noise reduction filters and techniques are applied to the generated waveform to extract the watermark and reject all other signals that are part of the original measurement. The noise-reduced waveform is then aligned at step 7.06 with a conversion template to convert the waveform into a binary representation of the watermark.

This embodiment provides an optional opportunity at step 7.07 for the user to inspect the waveform and the result of the template conversion, take advantage of the fact that the human eye may sometimes see patterns that elude automated algorithms, and apply appropriate corrections to the binary representation of the watermark.

Next, at step 7,08 the binary representation of the watermark is converted into a human-readable representation and is presented to the user for review.

As a part of this process, in this embodiment at step 7.09, error correction codes inherent in the watermark may be tested to validate the results of the decode process.

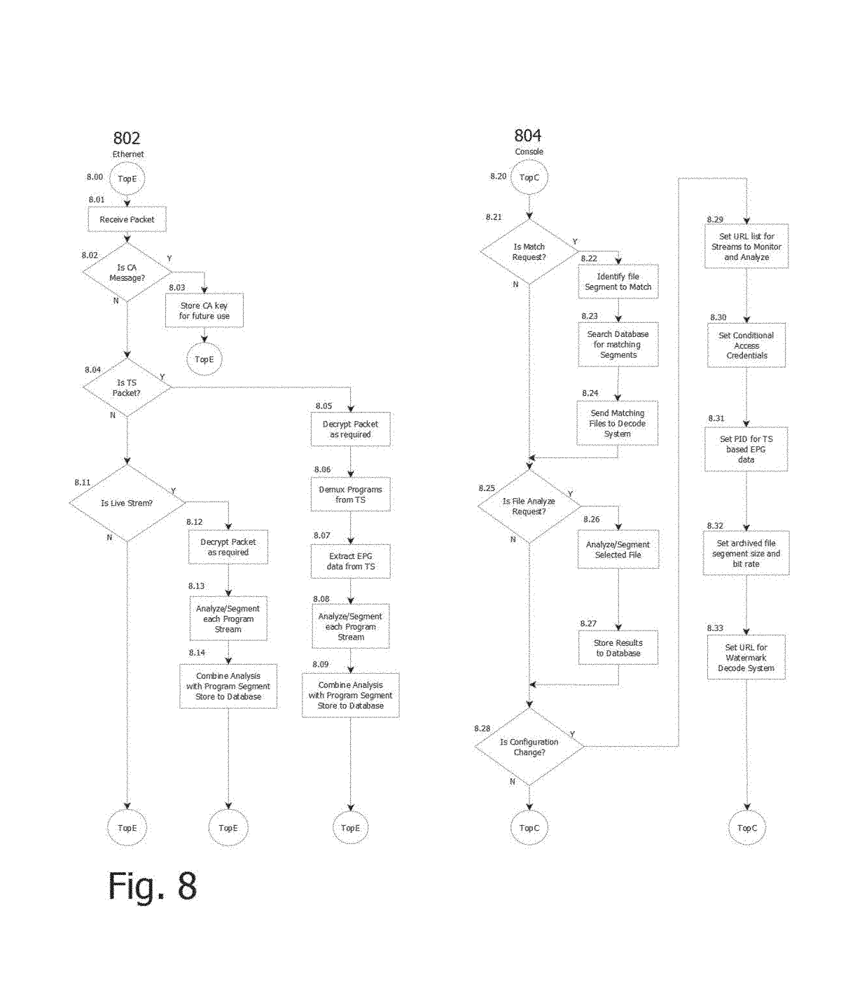

In the embodiment illustrated in FIG. 8, a watermark decode file match server manages the data required to collect and match media files for use in supplying inputs to the watermark decoder. In this embodiment, two concurrent threads are executed, with one Ethernet monitor thread 802 managing Ethernet communications, and another Console thread 804 managing actions requested from the server console.

Ethernet Monitor Thread. In the Ethernet monitor thread 802, beginning at step 8.00 (identified in FIG. 8 as “TopE”), at step 8.01 an Ethernet packet is received from a previously configured URL source that is to be monitored. At step 8.02 the packet is checked to determine whether it contains a message from a Conditional Access server containing updated decode keys. If the packet includes a message from the Conditional Access server, the message data is saved in step 8.03 for later use, and control reverts back to step 8.01.

At step 8.04 the packet is checked to determine if it is part of a monitored transport stream. Depending on the determination result, in this embodiment one of two different sequences is executed:

If the packet is part of a monitored transport stream, at step 8.05 the system determines whether the packet requires decryption, and if so, decrypts the data. The unencrypted packet is then de-multiplexed from the transport stream in step 8.06 and assigned to a particular program stream or ancillary data stream.

Next, at step 8.07 any Electronic Program Guide data is extracted from the packet and saved for inclusion as metadata in the resulting program segment file. The packet content is then analyzed in step 8.08 for a matching signature and other parameters useful for later decoding. This content is also decimated (i.e., the number of bits used reduced to encode each frame, thereby reducing the quality of the playback and making it less attractive to a potential copyright infringer) to a specified content bitrate if required before adding it to the current program segment file.

At step 8.09, the completed file segments are combined with metadata and analysis results, and stored in a database. Control then reverts back to step 8.00.

If on the other hand at step 8.04 the packet is determined to not be part of a monitored transport stream, at step 8.11 the system determines whether the packet is associated with a live stream. If not, control reverts back to step 8.00. If, however, the packet is associated with a live stream, the system at step 8.12 determines whether the packet requires decryption, and if so, decrypts the data, and then the packet content is analyzed at step 8.13 for a matching signature and other parameters useful for later decoding. This content is also decimated to specified content bitrate if required before adding it to the current program segment file.

After the processing in step 8.13, control passes to step 8.14, where completed file segments are combined with metadata and analysis results and stored in the database, and then control reverts back to step 8.00.

Console Thread. In the console thread beginning at step 8.20 (identified in FIG. 8 as “TopC”), at step 8.21 the system determines whether a received system operator input is a match request. If yes, control shifts to step 8.22, to identify the file segment or segments to use as the matching template. Specifically, in this embodiment at step 8.23 the system searches a database to find matching segments and returns an indication of the quality of the resulting matching, which optionally the system operator may also visually confirm. The matching files are then in step 8.24 sent to the system's decoding process at a URL identified in the system configuration (discussed further, below). Control then continues to step 8.25.

If at step 8.21 the received system operator input is determined to not be a match request, control proceeds directly to step 8.25, where the system then checks the operator input to see if it is a media file analysis request. If so, at step 8.26 the system executes a file analysis and segmentation process on the selected file, and the result of the analysis and segmentation process is stored in the database at step 8.27.

If at step 8.25 the received system operator input is determined to not be a media file analysis request, control proceeds to step 8.28 to determine whether the system operator input is a system configuration change request. If not, control reverts have to step 8.20 to await the next system operator input.

If the operator input is a system configuration change request, then global configuration items are identified. In this embodiment, video is to be delivered by multicast to the whole network, while this application only needs to receive data from the particular URL to be monitored. Thus, at step 8.29 a URL for each stream that is to be monitored, analyzed and segmented is identified, at step 8.30 conditional access credentials are identified, at step 8.31 the PID of TS-based electronic program guide (“EPG”) data and the URI, of stream-based EPG data are identified, at step 8.32 the target file size and target bit rate for the recorded file segments are identified, and at step 8.33 the URL of the Watermark Decode system to which the results of match requests need to be sent is identified. Control then reverts have to step 8.20 to await the next system operator input.

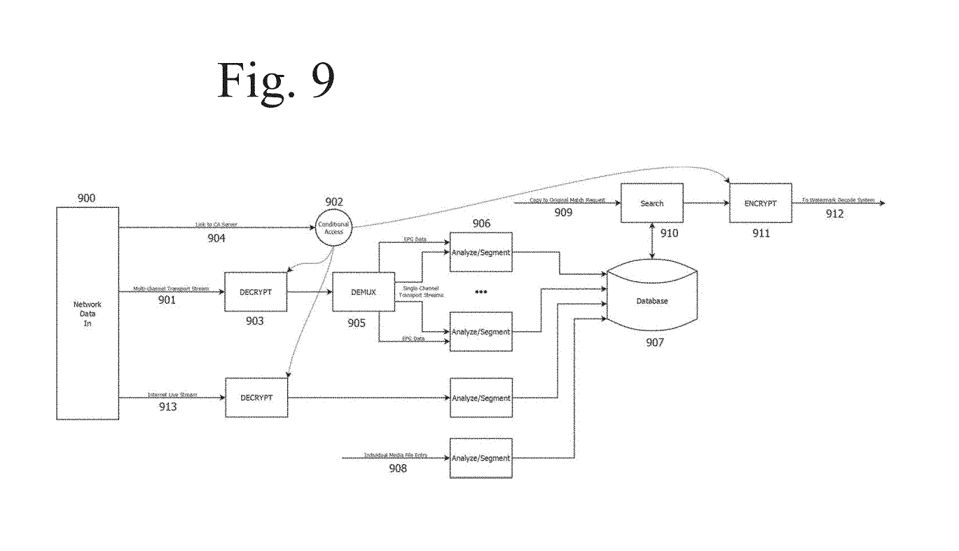

FIG. 9 schematically illustrates a system architecture embodiment supporting matching of a watermarked copy to an original. In this embodiment, content from a multi-channel transport stream 901 is decrypted in decryption process 903, if decryption is authorized by conditional access process 902 based on access information received from a link 904. The decrypted data is received by de-multiplexer 905. The de-multiplexed data, including both EPG data and program stream data, is analyzed and segmented on a single channel transport stream basis, for example in a looped manner, in analyze/segment processes 906, with the combined analysis and segment data being forwarded for storage in database 907. Analysis and segment data may also be added to the database 907 from an individual media file entry facility 908 after passing through an analyze/segment process 906.

The database 907 may also receive and respond to copy-to-original match requests 909 received by a search facility 910 which attempts to locate relevant original content (complete or in segments) for comparison to a corresponding copy of the content. If the database 907 responds with the requested comparison content, and if the conditional access process 902 allows, the content is encrypted in an encryption process 911 and forwarded via link 912 to a watermark decoding system (which may be local or remote) for subsequent extraction of the watermark data based on the information retrieved from the database 907.

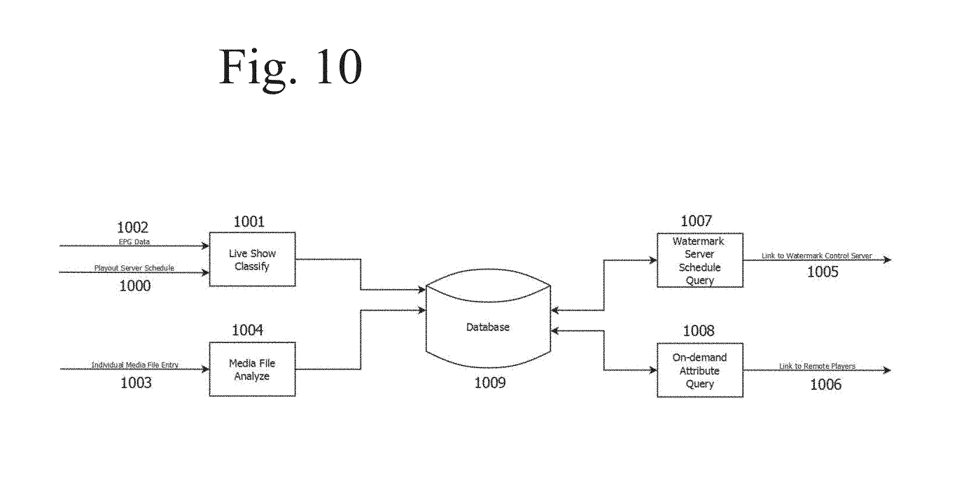

FIG. 10 schematically illustrates an embodiment of a system architecture supporting watermark context analysis, in which the database 1007 receives the classification of a live show from classifier 1001, based on EPG data 1001 received by the classifier. The database 1007 also receives media file analysis data regarding a corresponding individual media file entry 1003 from media file analyzer 1004. The information regarding content stored in the database likewise may be received as well as accessed via links to a watermark control server 1005 and remote player(s) 1006, as shown in this embodiment via a process handling watermark server schedule queries 1007 and a process handling on-demand attribute queries 1008, respectively.

For enhanced security in a web browser environment, optionally the watermarking system may be configured such that the endpoint display device previously described as a STB or handheld device is instead a web browser. The web browser may be supplemented with an independent security application. In one embodiment, the security application takes the form of a small-scale local server in which all requests to the remote video server site are redirected through the local server, which in turn requests the video data from the remote video web server. In this case, “local” refers to means an application running on the same computer as the web browser. The web browser thus accesses the local application through the local loopback address, such as 127.0.0.1, at which the local application functions as a web server. Data requests intended for a compatible remote video server are instead passed to the local server, which then reflects the requests to the remote video server. When the local server receives the response from the remote video server, it applies decryption and/or watermarking to the content before passing the data on to the web browser. This redirection to the local server can be made unobtrusive to the user by encapsulating the references to the local URL in Javascript sent from the remote web server. Of course, one skilled in the art will recognize that there are a number of other equivalent embodiments which might use other methods for communicating with the browser, such as the plug-in method or the device driver method.

The local server provides a more secure environment in which to execute such operations as decryption and watermark application. It further serves as a platform for monitoring attempts to bypass or tamper with the security features or to interface with physical security devices such as USB dongles or accessory cards.

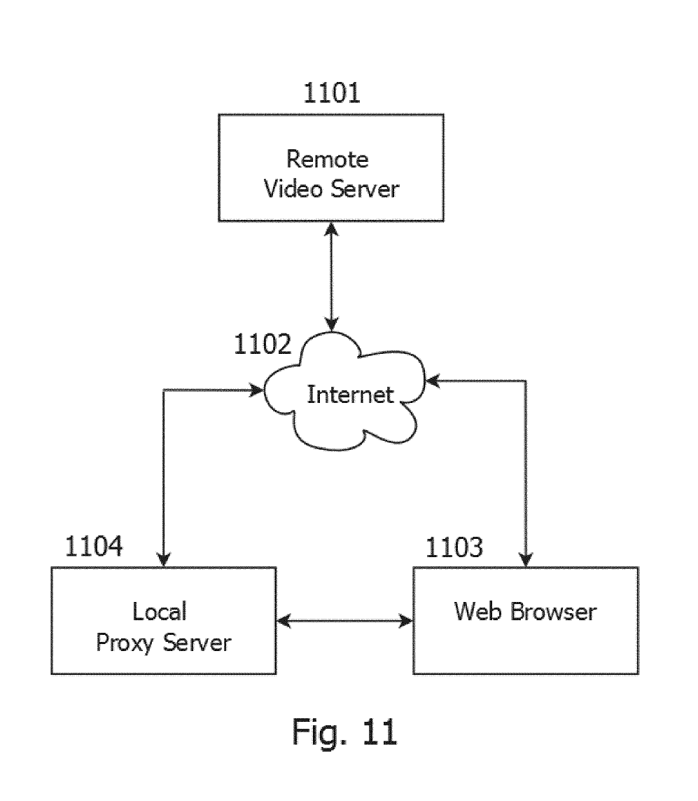

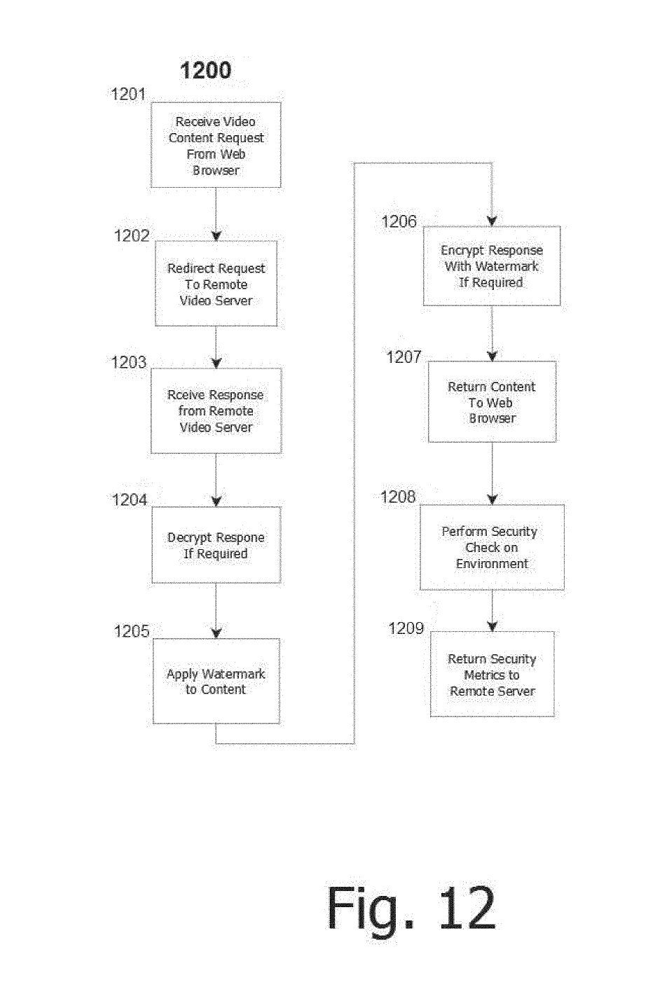

FIG. 11 illustrates an embodiment of a system in which the security of the application of a watermark in a web browser environment enhanced by the use of a hard coded application separate from the web browser. In this embodiment both a local web browser at 1103 and a local server 1104 of the present invention at an endpoint device have access to one another and the internet. A remote video content server 1101 is connected to the Internet 1102. Media content may be accessed from the remote video content server 1101 in the manner illustrated in FIG. 12.

FIG. 12 illustrates an embodiment of a code flow chart 1200 for a hard coded security application, which may act as a watermark proxy, separate from the web browser.

At step 1201 the local server 1104 receives a data request from web browser 1103 that is routed to the local server 1104 instead of to the Internet 1102. The local server 1104 at step 1202 redirects the request through Internet 1102 to the remote video server 1101.

The response from the remote server 1101 is received at the local server 1104 in step 1203, and if decryption is required at step 1204 the local server 1104 decrypts the response the remote server 1101.

At step 1205 the local server 1104 applies a watermark to the contents of the response received from remote server 1101, and if required encrypts the content with the watermark at step 1206. The local server 1104 then at step 1207 forwards the watermarked content to web browser 1103.

The local server 1104 in this embodiment also executes tests to determine whether its security is intact and whether there are efforts to tamper with or bypass the security. At step 1208 a security check in the environment is performed, and at step 1209 the local server 1104 transmits relevant tamper metrics to remote server 1101 for further remote processing.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for applying a plurality of watermarks to a broadcast multimedia work, comprising the steps of:
transmitting the broadcast multimedia work to a broadcast system endpoint device with a plurality of watermarks and a watermark strategy configured to vary at least one of the plurality of watermarks over time;
executing the watermark strategy at the device to vary the at least one watermark of the plurality of watermarks over time,
wherein the plurality of watermarks identifies at least one of the broadcast system endpoint device, an origin of the multimedia work, and an identity of the multimedia work in a manner enabling identification of an origin of an unauthorized copy of the broadcast multimedia work.

2. The method of claim 1, wherein the identification of the origin of an unauthorized copy of the broadcast multimedia work identifies a user associated with the device.

3. The method of claim 1, wherein the at least one of the plurality of watermarks is a modulation of image brightness.

4. The method of claim 1, wherein the at least one of the plurality of watermarks is a modulation of audio tone or equalization.

5. The method of claim 1, wherein the at least one of the plurality of watermarks is a modulation of audio phase relative to video.

6. The method of claim 1, wherein the at least one of the plurality of watermarks is a modulation of image horizontal and vertical placement.

7. The method of claim 1, wherein the at least one of the plurality of watermarks is a modulation of video color temperature.

8. The method of claim 1, wherein the at least one of the plurality of watermarks is a modulation of image anamorphic distortions.

9. The method of claim 1, wherein the at least one of the plurality of watermarks is a modulation of image black level.

10. The method of claim 1, wherein the at least one of the plurality of watermarks is a modulation of image hue.

11. The method of claim 1, wherein the at least one of the plurality of watermarks is a modulation of background noise floor.

12. The method of claim 1, wherein the at least one of the plurality of watermarks is a modulation of text characteristics.

13. The method of claim 1, wherein the modulation of text characteristics includes modulation of at least one of font size, boldness and tilt.

14. The method of claim 1, wherein the at least one of the plurality of watermarks is a modulation of a variable characteristic of the multimedia work.

15. The method of claim 1, wherein the at least one of the plurality of watermarks is at least one of visible and audible during presentation of the multimedia work.

16. The method of claim 1, wherein the at least one of the plurality of watermarks is not observable during presentation of the multimedia work.

17. The method of claim 1, wherein the at least one of the plurality of watermarks is inconsistent with the overall watermarking strategy in a manner that is misleading to a potential copyright infringer.

18. The method of claim 1, wherein in the step of executing the watermark strategy at the device at least two of the plurality of watermarks are applied sequentially.

19. The method of claim 1, wherein in the step of executing the watermark strategy at the device the plurality of watermarks are applied simultaneously.

20. The method of claim 1, wherein in the step of executing the watermark strategy at the device the plurality of watermarks are applied both sequentially and simultaneously.

21. The method of claim 1, wherein a modulation of the at least one of the plurality of watermarks is based on amplitude changes over time.

22. The method of claim 1, wherein a modulation of the at least one of the plurality of watermarks is based on amplitude changes over frequency.

23. The method of claim 1, wherein a modulation of the at least one of the plurality of watermarks is based on amplitude changes over both time and frequency.

24. The method of claim 1, wherein a modulation of the at least one of the plurality of watermarks is based on amplitude changes over space.

25. The method of claim 1, wherein a modulation of the at least one of the plurality of watermarks is based on amplitude changes over time and space.

26. The method of claim 1, wherein a modulation of the at least one of the plurality of watermarks is based on coefficient changes in an FFT or DCT representation of the multimedia work.

27. The method of claim 1, wherein a modulation of the at least one of the plurality of watermarks is based on coefficient changes in a wavelet representation of the multimedia work.

28. The method of claim 1, further comprising the step of:
transmitting to the endpoint device computer readable instructions for modulating a multimedia parameter of the broadcast multimedia work to at least one of create and alter a watermark.

29. The method of claim 1, further comprising the steps of:
executing on the endpoint device a tamper monitoring code; and
detecting with the tamper monitoring code attempts to circumvent the at least one of the plurality of watermarks.

30. A computer program fixed in a tangible medium configured to read at least one of the plurality of watermarks from a recorded copy of a multimedia work made according to the method of claim 1.

31. A method of file matching in a watermark decode process that include generation of a completed media file segment for storage in a media match database, the method of file matching comprising the steps of:
receiving at a watermark decode file match server an Ethernet packet from a monitored URL source;
determining with the watermark decode file match server whether the packet includes updated decode keys from a conditional access server;
if the packet includes updated decode keys, storing the updated decode keys and then restarting the watermark decode file matching process;
if the packet does not include updated decode keys, determining with the watermark decode file match server whether the packet is part of a monitored transport stream;
if the packet is part of a monitored transport stream, executing with the watermark decode file match server a packet analysis sub-process including the steps of
if the packet requires decryption, decrypting the data,
de-multiplexing the packet from the transport stream and associating multimedia content from the packet to a specific program stream or ancillary data stream,
if the packet includes electronic program guide data, storing the electronic program guide data in a form suitable for subsequent inclusion as metadata in a program segment file including the multimedia content from the packet,
if the packet includes decoding parameters, storing the decoding parameters for subsequent inclusion as metadata in the program segment file,
if the multimedia content from the packet has a content bitrate greater than a predetermined content bitrate, decimating the content to the predetermined content bitrate, and
storing in the database the completed media file segment formed from the decoded, decimated multimedia content, the metadata and the decoding parameters; and
if the packet is not part of a monitored transport stream, executing with the watermark decode file match server a live stream packet analysis sub-process including the steps of
if the packet requires decryption, decrypting the data,
de-multiplexing the packet from the transport stream and associating multimedia content from the packet to a specific program stream or ancillary data stream,
if the packet includes decoding parameters, storing the decoding parameters for subsequent inclusion as metadata in the program segment file,
if the multimedia content from the packet has a content bitrate greater than a predetermined content bitrate, decimating the content to the predetermined content bitrate, and
storing in the database the completed media file segment formed from the decoded, decimated multimedia content and the decoding parameters.

32. The method of file matching of claim 31, further comprising the steps of:
determining with the watermark decode file match server whether a received system operator input is a request to match at least one operator-identified media file segment;
if the received system operator input is a match request, executing a sub-process including the steps of
identifying with the watermark decode file match server at least one operator-identified media file segment,
searching the database of completed file segments to identify at least one completed media segment matching the at least one matching template file by, and
sending the matching segments to a predetermined URL associated with the file decoding process for decoding;
if the received system operator input is not a match request or if the received system operator input is a match request and the match request sub-process has been completed, determining with the watermark decode file match server whether the received system operator input is a request to analyze a selected media file;
if the received system operator input is a selected media file analysis request, executing with the watermark decode file match server a file analysis and segmentation process on the selected file and storing the analysis and segmentation analysis result in the database;
if the received system operator input is not a selected media file analysis request or if the received system operator input is a selected media file analysis request and the file analysis and segmentation process has been completed, determining with the watermark decode file match server whether the received system operator input is a system configuration change request;
if the received system operator input is a system configuration change request, identifying and storing with the watermark decode file match server global configuration data for each stream that is to be monitored, analyzed and segmented, the global configuration data including
a URL to be monitored,
conditional access credentials,
a PID and a URL of electronic program guide data,
a target file size and target bitrate for file segments, and
a URL of a recipient designated to receive results of match requests.

33. A method of file matching in a watermark decode process, comprising the steps of:
storing in a database accessible by a watermark decode file match server a completed media file segment of a media file, the completed media file segment including at least decoding parameters and a portion of the media file as decoded, multimedia content decimated to below a threshold hit rate;
receiving at the watermark decode file match server a request to match a media file segment from a media file;
searching the database of completed file segments to identify a completed media segment matching the received media file segment;
decoding the matching segments;
comparing the decoded matching segments to identify whether the received media segment differs from the matched completed media file segment in a manner indicative of unauthorized copying of the media file; and
if the received media segment differs from the matched completed media file segment in a manner indicative of unauthorized tampering or copying of the media file, executing a notification process to at least one of issuing an alert to prevent or halt playing of the media file on an endpoint device and identify from the received media segment an origin of an origin of the unauthorized copy of the media file.

34. The method of file matching in a watermark decode process of claim 33, wherein in the step of comparing the decoded matching segments, the matching media file segments are forwarded to a predetermined URL associated for decoding prior o the comparing step.
